(19) United States
(12) Patent Application Publication
(10) Pub. No.: US 2026/0075674 A1
(43) Pub. Date: Mar. 12, 2026

(54) DETECTION MECHANISM TO VALIDATE AND MANAGE FAULTY DEVICES

(71) Applicant: T-MOBILE INNOVATIONS LLC, Overland Park, KS (US)

(72) Inventors: Samir PATEL, Plano, TX (US); Roopesh Kumar POLAGANGA, Bothell, WA (US)

(21) Appl. No.: 18/830,868

(22) Filed: Sep. 11, 2024

(51) Int. Cl. H04W 76/18; H04W 8/18; H04W 8/30; H04W 48/02

(52) U.S. Cl. CPC H04W 76/18; H04W 8/18; H04W 8/30; H04W 48/02

(57) ABSTRACT

Systems and methods are provided for adding a detection mechanism and validation means to identify faulty devices to effectively manage them to improve network accessibility metrics. Carrier configuration can be utilized to dynamically disable/enable certain layers/bands/RAT in order to effectively manage which devices can attach to the network and to which layers they may attach. Such management techniques can be utilized when devices have met a predetermined failure threshold indicating the device has failed to return a radio resource control (RRCE) connection setup complete message a predetermined number of times within a predetermined time period (e.g., 10 failures within an hour from the same cell). This likely indicates a bad actor attempting to access the network and should be handled appropriately.

### SUMMARY

A high-level overview of various aspects of the present technology is provided in this section to introduce a selection of concepts that are further described below in the detailed description section of this disclosure. This summary is not intended to identify key or essential features of the claimed subject matter, nor is it intended to be used as an aid in isolation to determine the scope of the claimed subject matter.

In aspects set forth herein, systems and methods are provided for managing faulty devices. More particularly, in aspects set forth herein, systems and methods enable dynamic enabling or disabling of network layers for devices that have failed to communicate a radio resource control (RRC) connection setup complete message, indicating a network issue that may, in fact, be a device issue or a bad actor attempting to access the network.

### BRIEF DESCRIPTION OF THE SEVERAL VIEWS OF THE DRAWINGS

Implementations of the present disclosure are described in detail below with reference to the attached drawing figures, wherein:

FIG. 1 depicts a diagram of an exemplary network environment in which implementations of the present disclosure may be employed, in accordance with aspects herein;

FIG. 2 depicts a diagram of an exemplary communication diagram, in accordance with aspects herein;

FIG. 3 depicts a flow diagram of a method for managing faulty devices, in accordance with aspects herein;

FIG. 4 depicts a flow diagram of a method for managing faulty devices, in accordance with aspects herein; and

FIG. 5 depicts a diagram of an exemplary computing environment suitable for use in implementations of the present disclosure, in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. The following is a list of these acronyms:
3G Third-Generation Wireless Technology
4G Fourth-Generation Cellular Communication System
5G Fifth-Generation Cellular Communication System
AMF Access & Mobility Management Function
APN Access Point Name
CD-ROM Compact Disk Read Only Memory
CDMA Code Division Multiple Access
eNodeB Evolved Node B
GIS Geographic/Geographical/Geospatial Information System
gNodeB Next Generation Node B
GPRS General Packet Radio Service
GSM Global System for Mobile communications
iDEN Integrated Digital Enhanced Network
DVD Digital Versatile Discs
EEPROM Electrically Erasable Programmable Read Only Memory
LED Light Emitting Diode
LTE Long Term Evolution
MIMO Multiple Input Multiple Output
MD Mobile Device
PC Personal Computer
PCF Policy Control Function
PCS Personal Communications Service
PDA Personal Digital Assistant
RAM Random Access Memory
RET Remote Electrical Tilt
RF Radio-Frequency
RFI Radio-Frequency Interference
R/N Relay Node
ROM Read Only Memory
SINR Transmission-to-Interference-Plus-Noise Ratio
SMF Session Management Function
SNR Transmission-to-noise ratio
SON Self-Organizing Networks
TDMA Time Division Multiple Access
TXRU Transceiver (or Transceiver Unit)
UDM Unified Data Management Function
UDR Unified Data Repository
UE User Equipment
UPF User Plane Function

Further, various technical terms are used throughout this description. An illustrative resource that fleshes out various aspects of these terms can be found in Newton's Telecom Dictionary, 32d Edition (2022).

As used herein, the term “node” is used to refer to network access technology for the provision of wireless telecommunication services from a base station to one or more electronic devices, such as an eNodeB, gNodeB, etc.

Embodiments of the present technology may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, a traditional telecommunications network employs a plurality of base stations (i.e., cell sites, cell towers) to provide network coverage. The base stations are employed to broadcast and transmit transmissions to user devices of the telecommunications network. An access point may be considered to be a portion of a base station that may comprise an antenna, a radio, and/or a controller.

As employed herein, a UE (also referenced herein as a user device) or WCD can include any device employed by an end-user to communicate with a wireless telecommunications network. A UE can include a mobile device, a mobile broadband adapter, or any other communications device employed to communicate with the wireless telecommunications network. A UE, as one of ordinary skill in the art may appreciate, generally includes one or more antenna coupled to a radio for exchanging (e.g., transmitting and receiving) transmissions with a nearby base station.

The present disclosure is directed to managing faulty devices. In particular, the present disclosure is directed to managing access to the network for faulty devices. Typically, standard UE network registration consists of a 3-way radio resource control (RRC) handshake between the UE and a gNodeB (gNB). When a UE fails to send the final RRC connection message, it appears as though there is a network problem when, in fact, it may be a faulty device or a bad actor attempting to access the network. Thus, it is advantageous to manage these failed access attempts to both block bad actors from network access and to eliminate repeated failed attempts that consume network resources to troubleshoot and identify a problem that is not a network-side failure.

Accordingly, a first aspect of the present disclosure is directed to a system for managing faulty devices. The system comprises one or more processors and one or more computer-readable media storing computer-usable instructions that, when executed by the one or more processors, cause the one or more processors to: identify a missing connection message for a user device attempting to access a network; identify that the user device has met a failure threshold; identify an identifier associated with the user device associated with the missing connection message; determine that the identifier exists within the network; and communicate a disablement command, wherein the disablement command prevents the user device from attaching to a disabled layer identified in the disablement command.

A second aspect of the present disclosure is directed to a method for managing faulty devices. The method comprises identifying a missing connection message for a user device attempting to access a network; identifying that the user device has met a failure threshold; identifying an identifier associated with the user device associated with the missing connection message; determining that the identifier exists within the network; and communicating a disablement command, wherein the disablement command prevents the user device from attaching to a disabled layer identified in the disablement command.

Another aspect of the present disclosure is directed to a method for managing faulty devices. The method comprises identifying a missing radio resource control (RRC) connection message for a user device attempting to access a network; identifying that the user device has met a failure threshold; identifying an identifier associated with the user device associated with the missing RRC connection message; determining that the identifier does not exist within the network; and communicating RRC reject message to the user device, wherein the RRC reject message prohibits the user device from accessing the network.

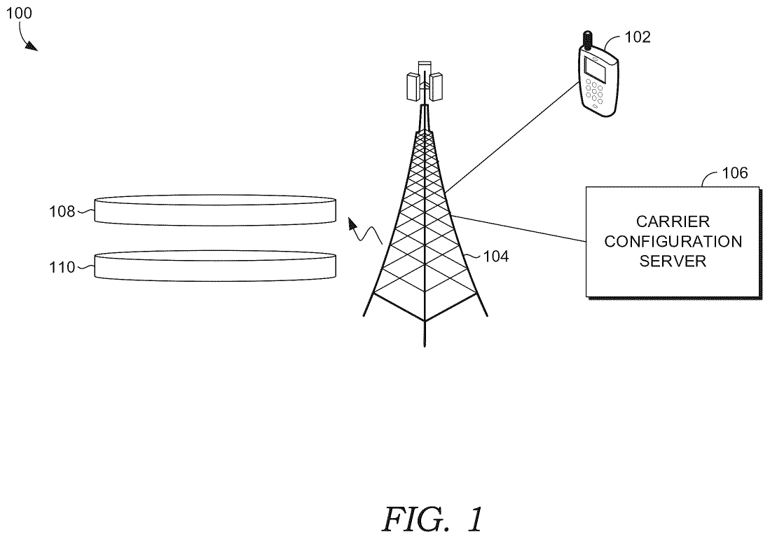

Turning to FIG. 1, a network environment suitable for use in implementing embodiments of the present disclosure is provided. Such a network environment is illustrated and designated generally as network environment 100. Network environment 100 is but one example of a suitable network environment and is not intended to suggest any limitation as to the scope of use or functionality of the disclosure. Neither should the network environment 100 be interpreted as having any dependency or requirement relating to any one or combination of components illustrated.

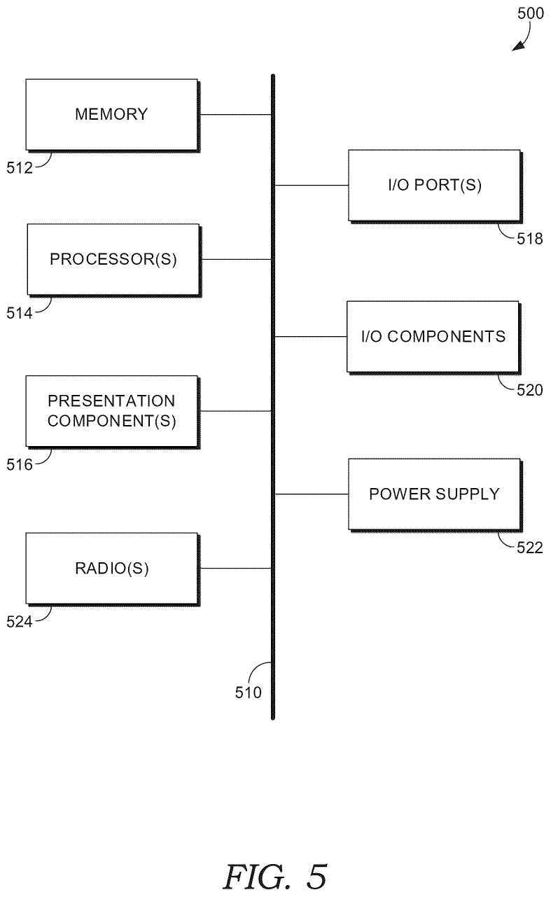

A network cell may comprise a base station to facilitate wireless communication between a communications device within the network cell, such as communications device 500 described with respect to FIG. 5, and a network. As shown in FIG. 1, communications device may be UE 102. In the network environment 100, UE 102 may communicate with other devices, such as mobile devices, servers, etc. The UE 102 may take on a variety of forms, such as a personal computer, a laptop computer, a tablet, a netbook, a mobile phone, a Smart phone, a personal digital assistant, or any other device capable of communicating with other devices. For example, the UE 102 may take on any form such as, for example, a mobile device or any other computing device capable of wirelessly communication with the other devices using a network. Makers of illustrative devices include, for example, Research in Motion, Creative Technologies Corp., Samsung, Apple Computer, and the like. A device can include, for example, a display(s), a power source(s) (e.g., a battery), a data store(s), a speaker(s), memory, a buffer(s), and the like. In embodiments, UE 102 comprises a wireless or mobile device with which a wireless telecommunication network(s) can be utilized for communication (e.g., voice and/or data communication). In this regard, the UE 102 can be any mobile computing device that communicates by way of, for example, a 5G network.

The UE 102 may utilize a network to communicate with other computing devices (e.g., mobile device(s), a server(s), a personal computer(s), etc.). In embodiments, the network is a telecommunications network, or a portion thereof. A telecommunications network might include an array of devices or components, some of which are not shown so as to not obscure more relevant aspects of the invention. Components such as terminals, links, and nodes (as well as other components) may provide connectivity in some embodiments. The network may include multiple networks. The network may be part of a telecommunications network that connects subscribers to their immediate service provider. In embodiments, the network is associated with a telecommunications provider that provides services to user devices, such as UE 102. For example, the network may provide voice services to user devices or corresponding users that are registered or subscribed to utilize the services provided by a telecommunications provider.

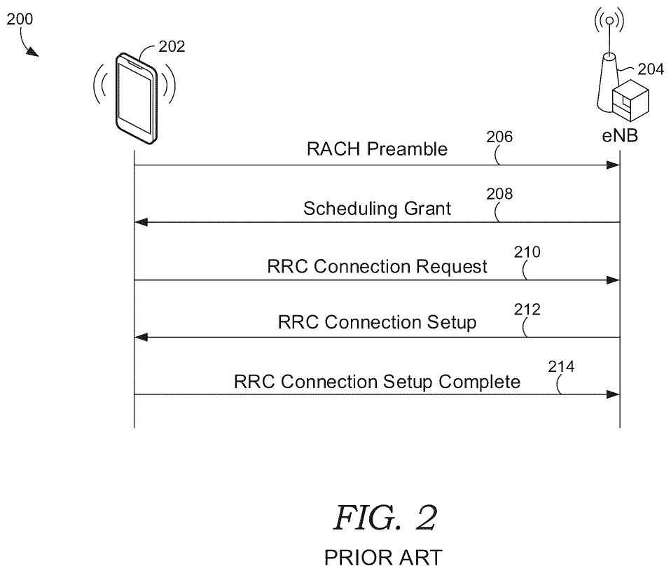

The UE 102, when attempting to access the network, begins the process by communicating with the gNB 104 in a series of steps that make up the registration process. FIG. 2 illustrates the typical network registration process 200 between a UE 202 and a gNB 204. The process begins with the random access channel (RACH) process that allows wireless devices to connect to the network and establish a connection with the gNB 204. This is illustrated in steps 206 and 208. Once RACH setup is complete and the UE 202 is in sync with the gNB 204, the UE 202 sends a RRC connection request message 210 to the gNB 204 to establish its identity and reason for joining the network. The gNB 204 responds to the UE 202 with a RRC connection setup message 212 that establishes a signaling radio bearer (SRB), unique identity, and other parameters. In the third and final step, the final RRC setup message, shown as RRC connection setup complete message 214, is sent from the UE 202 to the gNB 204 with UE network capability and other parameters. These settings allow the gNB 204 to communicate back to the core network for connection establishment.

There may be instances where a UE does not send back the third and final RRC message (message 214 of FIG. 2) and the cell site treats the session as an access failure. This is identified in network performance metrics as an access failure and network resources are allocated to identifying a network issue that caused the access failure. In some cases, such as poor RF coverage, this is acceptable. In other cases, where the UE repetitively attempts to connect to the gNB and the final RRC message 214 is missing, it is seen as though the cell site is performing poorly and possibly causing a service outage for that area.

Further investigation into the issue has identified that these repetitive attempts lacking the third RRC message (message 214) are generally UEs that are in a hung status (e.g., a device that has been sitting for months without use) or bad actors attempting to access the network. Since the UE cannot connect to the network, there is no way to contact the customer directly to troubleshoot, leaving the cell site to manage these bad sessions for days or weeks. Hence, there is a need for additional safeguards to manage this situation.

Carrier configuration is an existing mechanism with which devices communicate with a carrier configuration server 106 to receive certain carrier-specific settings and updates. Devices can communicate with the carrier configuration server 106 when a SIM is placed/activated in a new device or periodically to receive the latest operator settings. Disabling certain bands/layers is possible via carrier configuration. In the present disclosure, the gNB 104 can leverage the carrier configuration server 106 to disable specific bands of the network (e.g., band 108, band 110) if missing RRC messages are identified in association with a specific band.

The gNB 104 can track identifiers in order to identify devices. These identifiers may be a temporary mobile subscriber identity (TMSI), an international mobile subscriber identity (IMSI), and the like. Because the gNB 104 is tracking repetitive missing RRC complete message (message 214) from the same UE, it has to be able to track the UE somehow, so the identifiers are utilized for tracking. Initially, the gNB 104 will track access failures, or what is perceived as an access failure due to a missing RRC connection message 214. The gNB 104 can be configured with a predetermined configurable failure threshold such that when access failures of a UE 102 for a predetermined period of time meet the failure threshold, the gNB 104 is triggered to perform additional checks for validation before rejecting the UE 102. As such, the gNB 104 initially determines if failures per a specific TMSI (or other identifier) are greater than a configured failure threshold in a predetermined period of time. If the failure threshold is met, it is then determined if the TMSI exists in the network (i.e., if the UE has registered with the network in the past). In the case of a 5G network, the access and mobility function (AMF) is referenced as it handles the registration of UEs to the network and maintains records of authentications. The UE 102 (or TMSI associated therewith) will either exist in the AMF, or it will not have a record.

In the event it exists in the AMF, the historical records of that TMSI are accessed from the AMF. The carrier configuration server 106 is initiated for communication with the UE 102 regarding any disabled layers/bands. In aspects, the gNB 104 communicates a layer disablement command either to the carrier configuration server 106 or to the UE 102. In other aspects, the carrier configuration server 106 can communicate the disablement command to the UE 102. The layer disablement command identifies at least one layer of the network that is disabled for the UE 102 and to which the UE 102 cannot attach. The layer identified is based on the missing RRC message 214. If the UE 102 is attempting to connect to a first layer and fails to send the missing RRC message 214 repeatedly, the UE 102 can be prevented from accessing that layer in an attempt to redirect to another layer that may be successful. The layer disablement command may be associated with a timer such that the UE 102 is not prohibited from that layer indefinitely.

If the UE 102 is not reachable by the carrier configuration server 106, the gNB 104 communicates a RRC connect reject message to the UE 102, preventing the UE 102 from attaching to the network in any way. As with the layer disablement command, the RRC connect reject message may be associated with a timer such that the rejected TMSI is stored on the gNB 104 for a specific period of time in case of further attempts. Since the device is unable to perform the RRC connection request (message 210), then it will not be able to create accessibility failures for a missing message 214.

If the TMSI does not exist in the AMF, it is unknown to the network. In this instance, there is no historical information to validate that the TMSI is a legitimate device that has successfully attached to the network in the past. As such, the gNB 104 can communicate a RRC connect reject message to the UE 102 such that it is unable to perform the RRC connection request (message 210) and create accessibility failures. As mentioned above, the rejected TMSI is stored on the gNB 104 in case of further attempts and will be rejected for a predetermined period of time.

The detection mechanism to identify the missing third RRC message (message 214) and further identify if the device is known to the network provides an option to disable a layer for a known UE before simply rejecting it from attaching to the network. If the gNB 104 were to simply reject whenever the missing third message is identified, the device in question could simply move to another gNB, as the gNB rejection is specific to that cell site. Thus, the issue is simply being shifted to a different gNB. However, the carrier configuration server 106 is network-wide, meaning that when a band, such as an n41 band, is disabled for a UE, the band is disabled for the UE regardless of the cell site to which it attaches or the gNB to which it is communicating. This enhancement avoids disabling/rejecting UEs that are not bad actors but, rather, simply having network issues that may be solved by redirection to a different network layer.

In addition to disabling layers for known UEs, the gNB 104 may detect a different issue related to the missing RRC message. For instance, a software version of a device may be identified as having issues attaching to a specific layer, or having issues returning the missing RRC message. The gNB 104 in that instance could instruct the CCS 106 to disable the band that is known to have issues with the software version. Alternatively, the gNB 104 could communicate to the UE 102 to discontinue use of the software version having the issues that causes the RRC message 214 to not be communicated back to the gNB 104.

Machine learning capabilities can also be utilized by the system 100 to identify faulty devices. For instance, machine learning capabilities could identify a pattern with a location-specific issue (e.g., devices in X location are all having issues with missing RRC messages when connecting to X layer). Machine learning can also provide options to intelligently enable or disable layers based on a change in the location. For instance, if devices in location X are having issues with layer X, the system 100 can intelligently and dynamically disable layer X until it is detected that the device is no longer in location X. Another aspect may provide automatic layer disablement for a device that is known to have a software version that does not connect well with the layer.

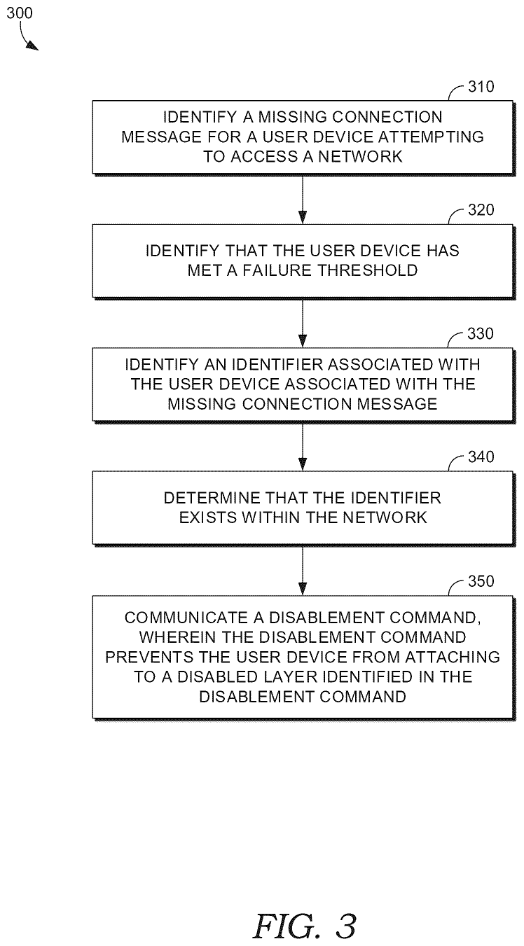

Turning to FIG. 3, a flow diagram 300 is provided illustrating a flow to manage faulty devices. Initially, at block 310, it is identified that a connection message is missing for a user device attempting to access a network. At block 320, it is identified that the user device has met a failure threshold. At block 330, an identifier associated with the user device associated with the missing connection message is identified. At block 340, it is determined that the identifier exists within the network. A disablement command is communicated at block 350. The disablement command prevents the user device from attaching to a disabled layer identified in the disablement command.

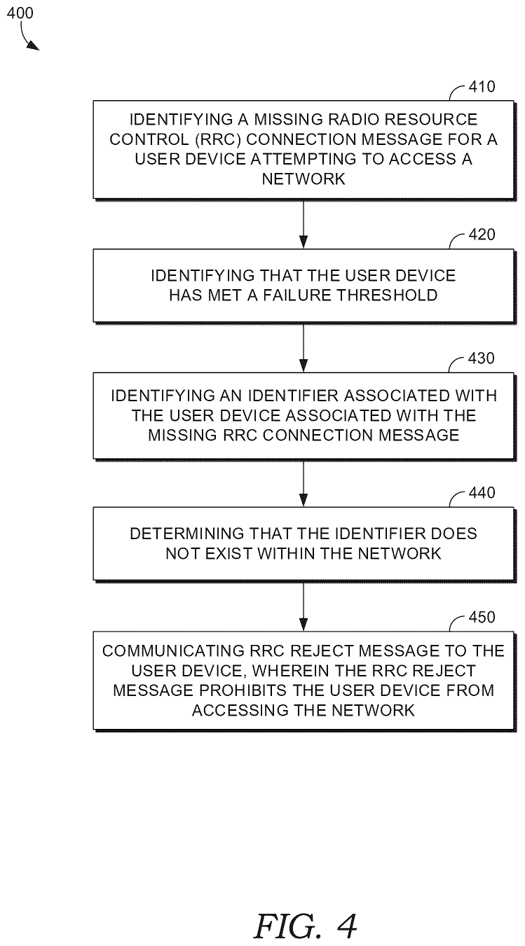

Referring to FIG. 4, a flow diagram 400 is provided illustrating a flow to manage faulty devices. Initially, at block 410, it is identified that a radio resource control (RRC) connection message is missing for a user device attempting to access a network. At block 420, it is identified that the user device has met a failure threshold. A failure threshold is a number of times the user device has failed to communicate a RRC connection message in a predetermined period of time. At block 430, an identifier associated with the user device associated with the missing RRC connection message is identified. It is determined that the identifier does not exist within the network at block 440. At block 450, a RRC reject message is communicated to the user device. The RRC reject message prohibits the user device from accessing the network.

Referring to FIG. 5, a block diagram of an exemplary computing device 500 suitable for use in implementations of the technology described herein is provided. In particular, the exemplary computer environment is shown and designated generally as computing device 500. Computing device 500 is but one example of a suitable computing environment and is not intended to suggest any limitation as to the scope of use or functionality of the invention. Neither should computing device 500 be interpreted as having any dependency or requirement relating to any one or combination of components illustrated. It should be noted that although some components in FIG. 5 are shown in the singular, they may be plural. For example, the computing device 500 might include multiple processors or multiple radios. In aspects, the computing device 500 may be a UE/WCD, or other user device, capable of two-way wireless communications with an access point. Some non-limiting examples of the computing device 500 include a cell phone, tablet, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

As shown in FIG. 5, computing device 500 includes a bus 510 that directly or indirectly couples various components together, including memory 512, processor(s) 514, presentation component(s) 516 (if applicable), radio(s) 524, input/output (I/O) port(s) 518, input/output (I/O) component(s) 520, and power supply(s) 522. Although the components of FIG. 5 are shown with lines for the sake of clarity, in reality, delineating various components is not so clear, and metaphorically, the lines would more accurately be grey and fuzzy. For example, one may consider a presentation component such as a display device to be one of I/O components 520. Also, processors, such as one or more processors 514, have memory. The present disclosure hereof recognizes that such is the nature of the art, and reiterates that FIG. 5 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of the present disclosure and refer to “computer” or “computing device.”

Memory 512 may take the form of memory components described herein. Thus, further elaboration will not be provided here, but it should be noted that memory 512 may include any type of tangible medium that is capable of storing information, such as a database. A database may be any collection of records, data, and/or information. In one embodiment, memory 512 may include a set of embodied computer-executable instructions that, when executed, facilitate various functions or elements disclosed herein. These embodied instructions will variously be referred to as “instructions” or an “application” for short.

Processor 514 may actually be multiple processors that receive instructions and process them accordingly. Presentation component 516 may include a display, a speaker, and/or other components that may present information (e.g., a display, a screen, a lamp (LED), a graphical user interface (GUI), and/or even lighted keyboards) through visual, auditory, and/or other tactile cues.

Radio 524 represents a radio that facilitates communication with a wireless telecommunications network. Illustrative wireless telecommunications technologies include CDMA, GPRS, TDMA, GSM, and the like. Radio 524 might additionally or alternatively facilitate other types of wireless communications including Wi-Fi, WiMAX, LTE, 3G, 4G, LTE, mMIMO/5G, NR, VoLTE, or other VoIP communications. As can be appreciated, in various embodiments, radio 524 can be configured to support multiple technologies and/or multiple radios can be utilized to support multiple technologies. A wireless telecommunications network might include an array of devices, which are not shown so as to not obscure more relevant aspects of the invention. Components such as a base station, a communications tower, or even access points (as well as other components) can provide wireless connectivity in some embodiments.

The input/output (I/O) ports 518 may take a variety of forms. Exemplary I/O ports may include a USB jack, a stereo jack, an infrared port, a firewire port, other proprietary communications ports, and the like. Input/output (I/O) components 520 may comprise keyboards, microphones, speakers, touchscreens, and/or any other item usable to directly or indirectly input data into the computing device 500.

Power supply 522 may include batteries, fuel cells, and/or any other component that may act as a power source to supply power to the computing device 500 or to other network components, including through one or more electrical connections or couplings. Power supply 522 may be configured to selectively supply power to different components independently and/or concurrently.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

What is claimed is:

1. A system for managing faulty devices, the system comprising:
one or more processors; and
one or more computer-readable media storing computer-usable instructions that, when executed by the one or more processors, cause the one or more processors to:
identify a missing connection message for a user device attempting to access a network;
identify that the user device has met a failure threshold;
identify an identifier associated with the user device associated with the missing connection message;
determine that the identifier exists within the network; and
communicate a disablement command, wherein the disablement command prevents the user device from attaching to a disabled layer identified in the disablement command.

2. The system of claim 1, wherein the missing connection message is a radio resource control setup complete message.

3. The system of claim 1, wherein the identifier is a temporary mobile subscriber identity (TMSI).

4. The system of claim 1, wherein the identifier is an international mobile subscriber identity (IMSI).

5. The system of claim 1, wherein the failure threshold indicates a predetermined number of times a user device can attempt to access the network and fail to send the missing connection message within a predetermined period of time.

6. The system of claim 1, wherein the disablement command is associated with a timer.

7. The system of claim 1, wherein the user device is able to access non-disabled layers of the network.

8. A method for managing faulty devices, the method comprising:
identifying a missing connection message for a user device attempting to access a network;
identifying that the user device has met a failure threshold;
identifying an identifier associated with the user device associated with the missing connection message;
determining that the identifier exists within the network; and
communicating a disablement command, wherein the disablement command prevents the user device from attaching to a disabled layer identified in the disablement command.

9. The method of claim 8, wherein the missing connection message is a radio resource control setup complete message.

10. The method of claim 8, wherein the identifier is a temporary mobile subscriber identity (TMSI).

11. The method of claim 8, wherein the identifier is an international mobile subscriber identity (IMSI).

12. The method of claim 8, wherein the failure threshold indicates a predetermined number of times a user device can attempt to access the network and fail to send the missing connection message within a predetermined period of time.

13. The method of claim 8, wherein the disablement command is associated with a timer.

14. The method of claim 8, wherein the user device is able to access non-disabled layers of the network.

15. The method of claim 8, further comprising identifying that the user device is unable to receive the disablement comment.

16. The method of claim 15, further comprising communicating a radio resource control reject message to the user device.

17. The method of claim 16, wherein the radio resource control reject message prohibits the user device from accessing the network.

18. A method for managing faulty devices, the method comprising:
identifying a missing radio resource control (RRC) connection message for a user device attempting to access a network;
identifying that the user device has met a failure threshold;
identifying an identifier associated with the user device associated with the missing RRC connection message;
determining that the identifier does not exist within the network; and
communicating RRC reject message to the user device, wherein the RRC reject message prohibits the user device from accessing the network.

19. The method of claim 18, wherein the identifier does not exist within the network when the user device has not registered with the network.

20. The method of claim 18, wherein the RRC reject message is associated with a timer.
